(19) United States
(12) Patent Application Publication
(10) Pub. No.: US 2026/0168875 A1
(43) Pub. Date: Jun. 18, 2026

(54) Bolt Axial Force Estimation Method and Bolt Axial Force Estimation System

(71) Applicant: Hitachi, Ltd., Chiyoda-ku, Tokyo (JP)

(72) Inventors: Norio ISHITSUKA, Tokyo (JP); Kisho ASHIDA, Tokyo (JP); Yusuke MIKI, Tokyo (JP)

(21) Appl. No.: 19/300,178

(22) Filed: Aug. 14, 2025

(30) Foreign Application Priority Data
Dec. 16, 2024 (JP) 2024-219621

(51) Int. Cl. G01L 5/24; G01L 1/22

(52) U.S. Cl. CPC G01L 5/24; G01L 1/22

(57) ABSTRACT

An object of the present invention is to provide a bolt axial force estimation method and a bolt axial force estimation system capable of evaluating a change in strain of a bolt with high accuracy. A bolt axial force estimation method of the present invention is a bolt axial force estimation method for a fastening member in which a body to be fastened is fastened by a nut and a bolt, the nut including a plurality of strain gauges arranged on a center in an axial direction or on a side closer to the body to be fastened than the center, the bolt axial force estimation method including: a measurement step of measuring a strain amount of the nut by the strain gauges attached to three outer surfaces of a nut outer surface at intervals of 120 degrees at equal distances from the body to be fastened and a nut contact surface; a calculation step of calculating a strain amount average value from the strain amount; and an estimation step of estimating a bolt axial force from the strain amount average value and a relationship between strain and bolt axial force prepared in advance.

### CLAIM OF PRIORITY

The present application claims priority from Japanese Patent application serial no. 2024-219621, filed on Dec. 16, 2024, the content of which is hereby incorporated by reference into this application.

### TECHNICAL FIELD

The present invention relates to a bolt axial force estimation method and a bolt axial force estimation system.

### BACKGROUND ART

A blade such as a windmill is fixed to a base by fastening several tens of bolts with nuts. Since a body to be fastened is made of resin such as GFRP, even if the nut is not loosened (even if the nut does not rotate), strain generated in the bolt due to creep of resin may be reduced. A strain gauge is attached to the bolt at an important position to monitor the strain of the bolt. As a method for attaching a strain gauge to a bolt, for example, a method described in PTL 1 is known. In this case, it is necessary to take out the wiring, and the wiring is passed through a bolt by making a hole.

### CITATION LIST

### Patent Literature

PTL 1: JP S63-270909 A

### SUMMARY OF INVENTION

### Technical Problem

In the above method, it takes time and effort to perform drilling on the bolt and pass the wiring through the hole of the bolt, and there has been a demand for an evaluation method capable of evaluating the strain of the bolt that does not require processing.

An object of the present invention is to provide a bolt axial force estimation method and a bolt axial force estimation system capable of evaluating a change in strain of a bolt with high accuracy.

### Solution to Problem

A bolt axial force estimation method of the present invention is a bolt axial force estimation method for a fastening member in which a body to be fastened is fastened by a nut and a bolt, the nut including a plurality of strain gauges arranged on a center in an axial direction or on a side closer to the body to be fastened than the center, the bolt axial force estimation method including: a measurement step of measuring a strain amount of the nut by the strain gauges attached to three outer surfaces of a nut outer surface at intervals of 120 degrees at equal distances from the body to be fastened and a nut contact surface; a calculation step of calculating a strain amount average value from the strain amount; and an estimation step of estimating a bolt axial force from the strain amount average value and a relationship between strain and bolt axial force prepared in advance.

Further, a bolt axial force estimation method of the present invention is a bolt axial force estimation method for a fastening member in which a body to be fastened is fastened by a hexagon nut and a bolt, the hexagon nut including a plurality of strain gauges arranged on a center in an axial direction or on a side closer to the body to be fastened than the center, the bolt axial force estimation method including: a measurement step of measuring a strain amount of the nut by the strain gauges attached at three non-adjacent surfaces among six surfaces of the hexagonal nut outer surface at equal distances from the body to be fastened and a nut contact surface; a calculation step of calculating a strain amount average value from the strain amount; and an estimation step of estimating a bolt axial force from the strain amount average value and a relationship between strain and bolt axial force prepared in advance.

Further, a bolt axial force estimation system of the present invention is a bolt axial force estimation system for a fastening member in which a body to be fastened is fastened by a nut in which a plurality of strain gauges is disposed on a center in an axial direction or on a side closer to the body to be fastened than the center and a bolt, the bolt axial force estimation system including: the strain gauges attached to three outer surfaces of a nut outer surface at intervals of 120 degrees at equal distances from the body to be fastened and a nut contact surface; a calculation unit that calculates a strain amount average value from the strain amount measured by the strain gauges; and an estimation unit that estimates a bolt axial force from the strain amount average value and a relationship between strain and bolt axial force prepared in advance.

Further, a bolt axial force estimation system of the present invention is a bolt axial force estimation system for a fastening member in which a body to be fastened is fastened by a hexagon nut and a bolt, the hexagon nut including a plurality of strain gauges arranged on a center in an axial direction or on a side closer to the body to be fastened than the center, the bolt axial force estimation system including: the strain gauges attached at three non-adjacent surfaces among six surfaces of the hexagonal nut outer surface at equal distances from the body to be fastened and a nut contact surface; a calculation unit of calculating a strain amount average value from the strain amount measured by the strain gauges; and an estimation unit that estimates a bolt axial force from the strain amount average value and a relationship between strain and bolt axial force prepared in advance.

### Advantageous Effects of Invention

According to the present invention, it is possible to provide a bolt axial force estimation method and a bolt axial force estimation system capable of evaluating a change in strain of a bolt with high accuracy.

### BRIEF DESCRIPTION OF DRAWINGS

FIG. 1 is a top view illustrating a strain gauge attachment position in a nut.

FIG. 2 is a side view of an A surface of the nut as viewed from the side.

FIG. 3 is a side view of a C surface of the nut as viewed from the side.

FIG. 4 is a side view of an E surface of the nut as viewed from the side.

FIG. 5 is a structural side view in which a body to be fastened is fastened by the nut to which strain gauges are attached and a bolt.

FIG. 6 is an explanatory diagram for explaining a bolt load and strain on a nut side surface.

FIG. 7 is a diagram illustrating the relationship between an axial force (load) of the bolt and the strain generated on the nut side surface.

FIG. 8 is an explanatory diagram for explaining the reason why strain measurement at 120 degrees and three surfaces is preferable.

FIG. 9 is a diagram for explaining a strain distribution generated on the nut side surface.

FIG. 10 is a diagram for explaining the influence of strain on the distance from the body to be fastened.

FIG. 11 is a diagram for explaining a mechanism of strain generated on the nut side surface.

### DESCRIPTION OF EMBODIMENTS

Hereinafter, preferred embodiments of the present invention will be described with appropriate reference to the drawings. However, the present invention is not limited to the embodiments described herein, and can be appropriately combined and improved without changing the gist.

### Embodiment

In the present embodiment, an axial force of a bolt is easily estimated using a correlation between the axial force of the bolt and strain on a nut side surface. A bolt axial force estimation method and a system for a fastening member in which a body to be fastened is fastened by a nut in which a plurality of strain gauges is arranged on the center in the axial direction or on a side closer to the body to be fastened side than the center and a bolt will be described.

The system according to the present embodiment is a bolt axial force estimation system for a fastening member in which a body to be fastened is fastened by a nut in which a plurality of strain gauges is arranged and a bolt on the center in the axial direction or on a side closer to the body to be fastened side than the center.

In addition, the system includes the strain gauges attached to three outer surfaces of the nut outer surface at intervals of 120 degrees at equal distances from the body to be fastened and the nut contact surface, a calculation unit that calculates a strain amount average value from the strain amounts measured by the strain gauges, and an estimation unit that estimates the bolt axial force from the strain amount average value and a relationship between the strain and the bolt axial force prepared in advance.

Then, a measurement step of measuring the strain amount of the nut, a calculation step of calculating a strain amount average value from the strain amount, and an estimation step of estimating the bolt axial force from the strain amount average value and a relationship between the strain and the bolt axial force prepared in advance are performed by strain gauges attached to three outer surfaces of the nut outer surface at intervals of 120 degrees at equal distances from the body to be fastened and the nut contact surface.

Further, the nut may be attached to three non-adjacent surfaces (A surface 7, C surface 9, E surface 11) of the outer surfaces (six surfaces) of the hexagon nut.

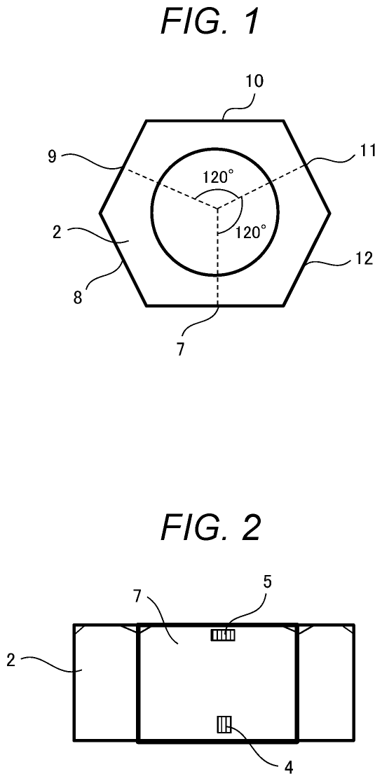

FIG. 1 is a top view illustrating a strain gauge attachment position in a nut. A state in which strain gauges 4 and a strain gauge 5 for temperature correction are attached to a nut 2 is illustrated. A correction step by the strain gauge 5 for temperature correction leads to improvement in estimation accuracy of the bolt axial force.

The strain gauges 4 are attached to three non-adjacent surfaces (A surface 7, C surface 9, E surface 11) of the outer surfaces (six surfaces) of the nut 2, and each of the strain gauges 4 is attached at intervals of 120 degrees in the circumferential direction of the nut. In addition, the strain gauge 5 for temperature correction is attached at one location on the opposite side (although not illustrated, the side opposite to the body to be fastened 3) of the same surface as the strain gauge 4. Although different surfaces are possible, the same surface is convenient because it does not interfere when tightening the nut 2.

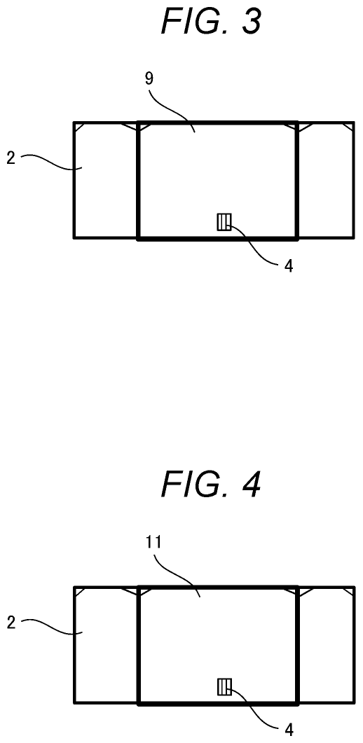

FIG. 2 is a side view of the A surface of the nut as viewed from the side, FIG. 3 is a side view of the C surface of the nut as viewed from a side surface, and FIG. 4 is a side view of the E surface of the nut as viewed from the side. In this manner, the strain gauge 4 and the strain gauge 5 for temperature correction are arranged on the A surface 7 of the nut 2. In addition, the strain gauge 4 is arranged on the C surface 9 of the nut 2, and the strain gauge 4 is arranged on the E surface 11 of the nut 2.

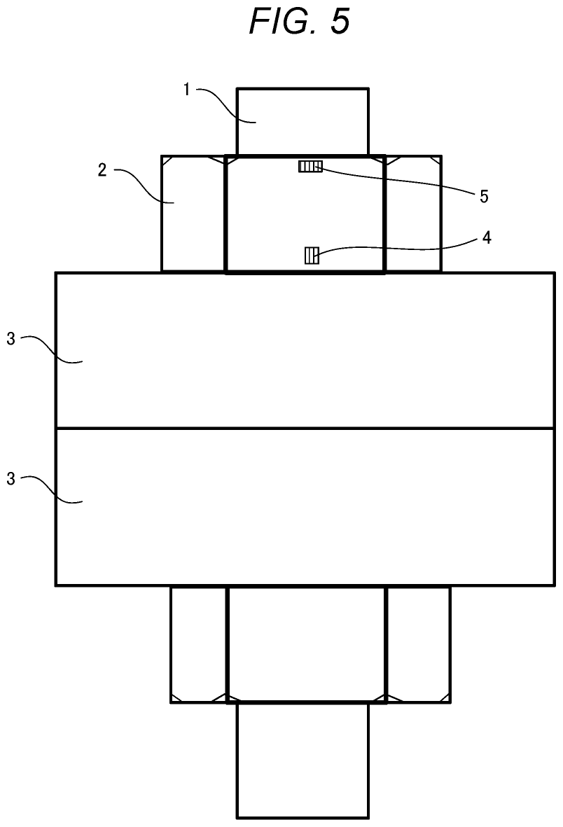

The strain gauge 5 for temperature correction is attached in a direction of measuring strain in the left-right direction in FIG. 1. Further, the three strain gauges 4 are attached at substantially the same distance from the nut end portion where the body to be fastened 3 and the nut 2 are in contact with each other. Note that the strain gauge 4 and the temperature correction strain gauge 5 are arranged substantially at the center of the width (left-right direction in the drawing) of the outer surface (one of six surfaces) of the nut 2 in FIG. 1. Further, in FIG. 1, the strain gauge 4 is attached in the vicinity of the body to be fastened 3 described later. FIG. 5 illustrates a state in which the nut 2 to which the strain gauges 4 and the strain gauge 5 for temperature correction are attached illustrated in FIG. 1 is attached to the body to be fastened 3.

FIG. 5 is a structural side view in which the body to be fastened is fastened by the nut to which the strain gauges are attached and a bolt. The body to be fastened 3 is fastened by bolts 1 and nuts 2 from both surfaces in the vertical direction in the drawing. The strain gauge 4 and the strain gauge 5 for temperature correction are arranged on the A surface 7 which is an outer peripheral surface of the nut 2.

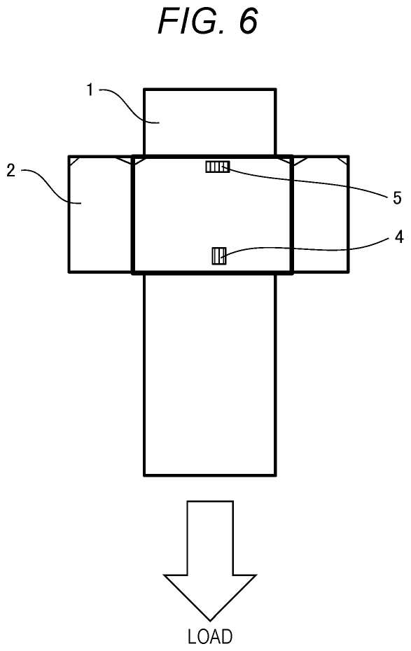

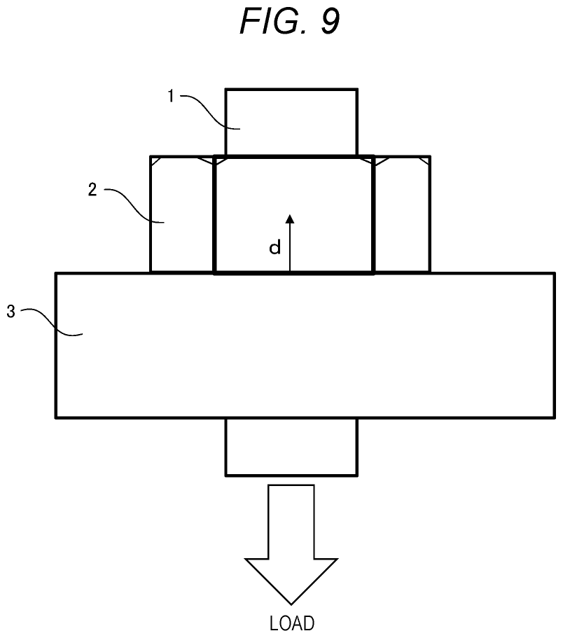

Next, effects of the present structure will be described. FIG. 6 is an explanatory diagram for explaining a bolt load and strain on a nut side surface. FIG. 9 is a diagram for explaining a strain distribution generated on the nut side surface. As illustrated in FIG. 9, the nut 2 to which the strain gauges 4 and the temperature correction strain gauge 5 illustrated in FIG. 1 were attached was attached to the body to be fastened 3 with the bolt 1, and a load was applied to the lower end of the bolt to measure the generated strain. In addition, in order to examine the influence of the rotation of the nut 2, a test was also performed in which the nut 2 was rotated at 0 degrees, 45 degrees, and 90 degrees.

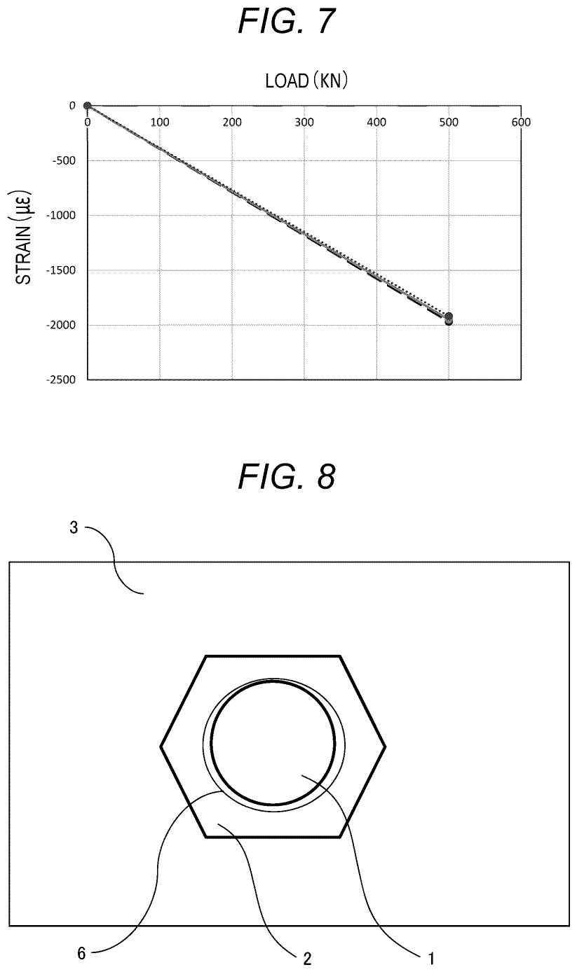

FIG. 7 is a diagram illustrating the relationship between the axial force (load) of the bolt and the strain generated on the nut side surface. It can be seen that the respective measured values are in a proportional relationship. The axial force (load) of the bolt can be grasped by measuring the strain generated on the nut side surface.

FIG. 11 is a diagram illustrating a mechanism of strain generated on the nut side surface. The relationship between load and strain is illustrated. This value indicates an average value of the three strain gauges 4. As can be seen from FIG. 11, even when the nut 2 is rotated, the error in the relationship between the load of the bolt and the strain average value of the nut 2 is small, and the measurement can be performed with high accuracy. Although not illustrated, in the strain measurement of only one surface of the nut 2, the angle dependence largely varies. From the result of FIG. 11, the relationship between the load of the bolt and the strain generated on the outer surface of the nut 2 can be seen. Using this calibration curve, the axial force of the bolt can be estimated from the strain in a case of actual installation.

FIG. 8 is an explanatory diagram for explaining the reason why strain measurement at 120 degrees and three surfaces is preferable. A relationship between the hole 6 of the body to be fastened and the bolt 1 and the nut 2 is illustrated. Since the bolt 1 is not necessarily arranged at the center of the hole 6 of the body to be fastened, the influence of eccentricity can be eliminated by arranging three strain gauges 4 at intervals of 120 degrees on the outer surface of the nut 2. That is, highly accurate strain can be acquired by attaching the strain gauges at intervals of 120 degrees from the A surface, the C surface, and the E surface in FIG. 1 and obtaining the average. Although the measurement was performed on three surfaces this time, the measurement may be performed on more surfaces, but three surfaces are sufficient from the viewpoint of measurement accuracy. Below this, the accuracy is extremely reduced.

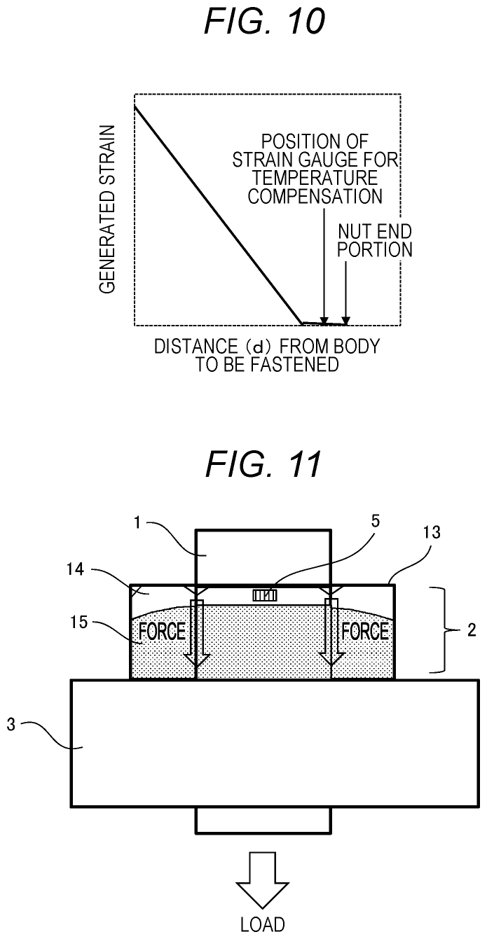

FIG. 9 is a diagram for explaining a strain distribution generated on the nut side surface. Further, FIG. 10 is a diagram for explaining the influence of strain on the distance from the body to be fastened. The outline of the strain generated on the nut outer surface is illustrated. In the drawing, the horizontal axis represents the distance d from the interface between the body to be fastened 3 and the nut 2, and the vertical axis represents the generated strain. A plurality of strain gauges is attached to the nut outer surface and acquired. From this drawing, the generated strain is high in the vicinity of the interface between the body to be fastened 3 and the nut 2, and the generated strain decreases as the distance d increases. In addition, as d was increased, the strain generated in the vicinity of the nut end portion hardly occurred. Therefore, in order to detect strain with higher accuracy, it is preferable that the strain gauge 4 is attached to the body to be fastened side from the nut height center (width center) from the viewpoint of detecting a high strain field.

As illustrated in FIG. 11, the load applied to the bolt acts on the interface between the nut and the bolt. Therefore, the closer the load is to the body to be fastened, the larger the strain becomes. On the other hand, in the nut on the side opposite to the body to be fastened, the threading in the nut does not reach the end portion. That is, the nut end portion is not threaded.

In addition, since the corner portion of the nut is a free end, there is almost no strain. By arranging the strain gauge 5 for temperature correction in this region, it is possible to cancel the amount of strain due to temperature change, and it is possible to detect strain amount with higher accuracy. The strain gauge 4 acquires the strain rotated by 90 degrees, so that the generated strain is reduced by a Poisson's ratio of 0.3, and thus the temperature can be more easily corrected.

The strain amount is temperature-corrected by the strain gauge for temperature correction attached to the opposite end portion of the body to be fastened on the nut side surface in a direction in which the longitudinal direction of the bolt and the longitudinal direction of the strain gauge are rotated by 90 degrees, so that it is possible to cancel the strain amount due to temperature change, and it is possible to detect the strain with higher accuracy.

According to the present embodiment, since the strain gauges are attached to three outer surfaces at intervals of 120 degrees, and the strain gauges are attached at equal distances from the body to be fastened and the nut contact surface, the change in strain of the bolt can be evaluated with high accuracy.

A part of the configuration of the embodiment can be added, deleted, or replaced without impairing the gist of the present invention.

### REFERENCE SIGNS LIST

1 bolt
2 nut
3 body to be fastened
4 strain gauge
5 temperature correction strain gauge
6 hole of body to be fastened
7 A surface
8 B Surface
9 C surface
10 D surface
11 E surface
12 F surface

1. A bolt axial force estimation method for a fastening member in which a body to be fastened is fastened by a nut and a bolt, the nut including a plurality of strain gauges arranged on a center in an axial direction or on a side closer to the body to be fastened than the center, the bolt axial force estimation method comprising:
a measurement step of measuring a strain amount of the nut by the strain gauges attached to three outer surfaces of a nut outer surface at intervals of 120 degrees at equal distances from the body to be fastened and a nut contact surface;
a calculation step of calculating a strain amount average value from the strain amount; and
an estimation step of estimating a bolt axial force from the strain amount average value and a relationship between strain and bolt axial force prepared in advance.

2. A bolt axial force estimation method for a fastening member in which a body to be fastened is fastened by a hexagon nut and a bolt, the hexagon nut including a plurality of strain gauges arranged on a center in an axial direction or on a side closer to the body to be fastened than the center, the bolt axial force estimation method comprising:
a measurement step of measuring a strain amount of the nut by the strain gauges attached at three non-adjacent surfaces among six surfaces of the hexagonal nut outer surface at equal distances from the body to be fastened and a nut contact surface;
a calculation step of calculating a strain amount average value from the strain amount; and
an estimation step of estimating a bolt axial force from the strain amount average value and a relationship between strain and bolt axial force prepared in advance.

3. The bolt axial force estimation method according to claim 1,
further comprising a correction step of performing temperature correction on the strain amount by a temperature correction strain gauge attached to the nut.

4. The bolt axial force estimation method according to claim 3, wherein
the strain amount is temperature-corrected by the strain gauge for temperature correction attached to an end portion of a nut side surface opposite to the body to be fastened in a direction in which a longitudinal direction of the bolt and a longitudinal direction of the strain gauge are rotated by 90 degrees.

5. A bolt axial force estimation system for a fastening member in which a body to be fastened is fastened by a nut and a bolt, the nut including a plurality of strain gauges arranged on a center in an axial direction or on a side closer to the body to be fastened than the center, the bolt axial force estimation system comprising:
the strain gauges attached to three outer surfaces of a nut outer surface at intervals of 120 degrees at equal distances from the body to be fastened and a nut contact surface;
a calculation unit that calculates a strain amount average value from the strain amount measured by the strain gauges; and
an estimation unit that estimates a bolt axial force from the strain amount average value and a relationship between strain and bolt axial force prepared in advance.

6. A bolt axial force estimation system for a fastening member in which a body to be fastened is fastened by a hexagon nut and a bolt, the hexagon nut including a plurality of strain gauges arranged on a center in an axial direction or on a side closer to the body to be fastened than the center, the bolt axial force estimation system comprising:
the strain gauges attached at three non-adjacent surfaces among six surfaces of the hexagonal nut outer surface at equal distances from the body to be fastened and a nut contact surface;
a calculation unit that calculates a strain amount average value from the strain amount measured by the strain gauges; and
an estimation unit that estimates a bolt axial force from the strain amount average value and a relationship between strain and bolt axial force prepared in advance.

7. The bolt axial force estimation system according to claim 5,
further comprising a temperature correction strain gauge attached to the nut for temperature correction of the strain amount.

8. The bolt axial force estimation system according to claim 7, wherein the strain gauge for temperature correction is attached to an end portion of a nut side surface opposite to the body to be fastened in a direction in which a longitudinal direction of the bolt and a longitudinal direction of the strain gauge are rotated by 90 degrees.
